(19) United States
(12) Patent Application Publication
(10) Pub. No.: US 2023/0217943 A1
(43) Pub. Date: Jul. 13, 2023

(54) ROBUST FLAVOR EMULSIONS

(71) Applicant: International Flavors & Fragrances Inc., New York, NY (US)

(72) Inventors: Daniel Lee, Union Beach, NJ (US); Adam Toth, Union Beach, NJ (US); Nicholas Christian Apollo, Union Beach, NJ (US); Ronald Gabbard, Union Beach, NJ (US)

(21) Appl. No.: 17/998,165

(22) PCT Filed: May 14, 2021
(86) PCT No.: PCT/US2021/032482

§ 371 Date: Nov. 8, 2022

Related U.S. Application Data
(60) Provisional application No. 63/024,993, filed on May 14, 2020.

(51) Int. Cl. A23D 7/005; A23L 2/04; A23L 2/60; A23L 2/68; A23L 2/56; A23D 7/04

(52) U.S. Cl. CPC A23D 7/0053; A23L 2/04; A23L 2/60; A23L 2/68; A23L 2/56; A23D 7/04

(57) ABSTRACT

An oil-in-water emulsion is disclosed. The oil-in-water emulsion contains an oil phase, an aqueous phase, and an emulsifier system. The emulsifier system can include modified starches such as octenyl succinic anhydride (OSA)-modified starch. The disclosed oil-in-water emulsions can include acidulants and can have a pH less than 5.0. Also disclosed are consumer products and methods of preparing the oil-in-water emulsion.

### BACKGROUND

Oil-in-water emulsions have been used to deliver functional ingredients in beverages and other consumable products for improved flavor experience and health benefits. Due to different physicochemical properties of functional ingredients, there lacks an emulsion system that is suitable for delivering a wide variety of functional ingredients.

Current emulsion systems have been developed to stabilize specific functional ingredients. U.S. Pat. No. 8,883,241 B2 discloses an emulsion for dispersing lipids using starch-containing finely ground pulse seed. U.S. Pat. No. 8,513,311 B2 focuses on the delivery of crystallinic lipophilic or amphiphilic nutrients with the aid of a lipophilic additive. US 2012/0040056 A1 is directed to a coconut-base emulsion. The solutions proposed in these patent documents are insufficient for a broad range of functional ingredients.

Flavor modulators including sweetness enhancers have received much attention due to their health benefits. See WO 2017/218072 A1 and WO 2009/085762 A1. These patent documents offer little help to address the challenges in delivery of the flavor modulators.

There is a need to develop a robust emulsion that allows a broader palette of functional ingredients in food, beverage, and pharmaceutical products.

### SUMMARY OF THE INVENTION

This invention is based on the discovery of a robust emulsion that allows formulating a broader palette of flavor ingredients and other functional ingredients such as colors, modulators, nutrients such as vitamins, and nutraceutical ingredients such as cannabidiol (CBD).

Accordingly, one aspect of this invention relates to an oil-in-water emulsion containing a plurality of oil droplets as an oil phase, an aqueous phase, and an emulsifier system, in which each of the oil droplets, having a droplet size of 0.05 μm to 10 μm in diameter, contains a functional ingredient system and disperses in the aqueous phase, and the emulsifier system contains an octenyl succinic anhydride (OSA)-modified starch having a weight average molecular weight (Mw) of 3,000 Dalton or less as measured by gel permeation chromatography (GPC) at a pH of 2.0. Additionally, the emulsifier system can also contain maltose at 0.5% to 80% (e.g., 5% to 75%, 10% to 70%, 20% to 65% and 30% to 60%). In some embodiments, the OSA-modified starch contains maltose in an amount of from about 15% to about 60%.

The mean oil droplet size is 1 μm or less in diameter and the volume distribution of oil droplet size is 60% or higher (e.g., 75% or higher and 90% or higher) below 1 μm.

Typically, the oil phase is present at a level of 1% to 30%, the emulsifier system is present at a level of 1% to 30%, and the functional ingredient system is present at a level of 0.1% to 20%, all by weight of the oil-in-water emulsion.

The emulsifier system can further contain a co-emulsifier that is a chemically modified starch having a weight average molecular weight of greater than 10,000 Dalton as measured by GPC at a pH of from about 2.0 to about 4.5. The weight ratio between the OSA-modified starch and co-emulsifier is 5:1 to 1:10, preferably 3:1 to 1:5. The weight ratio between the emulsifier system and the oil phase is 1:10 to 2:1, or preferably 1:5 to 1:1.

The functional ingredient system contains one or more ingredients selected from the group consisting of a flavor oil, a taste modulator, an acidulant, a carbohydrate, a nutraceutical ingredient, a colorant, a juice, a plant extract, a vitamin, and any combinations thereof.

Taste modulators can be a steviol-based compound, a non-steviol-based compound, or both. Steviol-based compounds include glucosylated steviol glycosides. Non-steviol-based compounds include Luo Han fruit extract. Other suitable taste modulators include those described in WO 2017/218072 A1, WO 2009/085762 A1, U.S. Pat. No. 9,603,373 B2, U.S. Pat. No. 9,107,436 B2, U.S. Pat. No. 9,420,815 B2, U.S. Pat. No. 8,524,785 B2, U.S. Pat. No. 8,277,861 B2, US 2009/0162487 A1, US 2010/0112138 A1, EP 1 399 034 B1 and EP 1 649 759 B1.

Optionally, the acidulant is presented at a level of 0.1% to 2% (e.g., 0.2% to 1%, and 0.2% to 0.75%) and is citric acid, ascorbic acid, tartaric acid, malic acid, gluconic acid, or a combination thereof, and the carbohydrate is presented at a level of 0.1% to 20% (0.5% to 15% and 1% to 5%) and is a monosaccharide, disaccharide, polysaccharide, or a combination thereof. Exemplary monosaccharides are glucose, fructose, galactose, ribose, and xylose. Exemplary disaccharides are sucrose, maltose, and lactose. Exemplary polysaccharides are xanthan gum, guar gum, and pectin.

Preferably, the oil phase contains a flavor compound and a taste modulator, and optionally a weighting agent, an antioxidant, a plant-based oil, a medium chain triglyceride, or a combination thereof. The density of the oil phase is preferably in the range of 0.9 g/L to 1 g/L (e.g., 0.92 g/L to 0.98 g/L).

The pH of the oil-in-water emulsion is preferably set to 5 or below (e.g., 4 or below, 3.5 to 4.5, and 2.5 to 4.5).

Another aspect of this invention is a consumer product containing any oil-in-water emulsion described above. The consumer product can be a liquid beverage, liquid beverage concentrate, or dry beverage powder.

Also within the scope of this invention is a method of preparing a flavor composition, the method comprising the steps of: (a) providing an aqueous phase containing an OSA-modified starch having a weight average molecular weight (Mw) of 3,000 Dalton or less as measured by GPC at a pH of 2.0, (b) providing an oil phase containing a flavor oil, and (c) emulsifying the oil phase into the aqueous phase, thereby obtaining the oil-in-water emulsion. Preferably, the aqueous phase contains a taste modulator. The method can also include a step of adding an acidulant to the aqueous phase to adjust the pH to below 5. The method can also include the step of spray drying the oil-in-water emulsion to obtain the flavor composition in the dry form.

The term “modified starch” refers to enzymatically or chemically treated starch. The term “OSA-modified starch” refers to a starch (from any natural source such as corn, waxy, maize, waxy corn, wheat, tapioca and potato or synthesized) that is chemically treated with octenyl succinic anhydride (OSA). A modified starch (including an OSA-modified) has a chemical structure which provides it with a hydrophilic and a lipophilic portion. See 0. B. Wurzburg, ed., Modified Starches: Properties and Uses, (Boca Raton: CRC Press, 1986). Preferably, a modified starch has a long hydrocarbon chain as part of its structure, preferably a C15-0500 (e.g., C15-C300, C20-C200, and C30-C100) chain. The degree of substitution, i.e. the number of hydroxyl groups esterified with OSA to the number of free non-esterified hydroxyl groups usually varies in a range of from 0.1% to 10%, preferably in a range of from 0.5% to 4%, more preferably in a range of from 3% to 4%. In some embodiments, the OSA-modified starch contains maltose in an amount of from about 15% to about 60% w/w by weight of the OSA-modified starch. In other embodiments, the amount of maltose in the OSA-modified starch is from about 15%, 20%, 25%, 30%, 35%, 40%, 45%, 50%, or 55% to about 20%, 25%, 30%, 35%, 40%, 45%, 50%, 55%, or 60% w/w by weight of the OSA-modified starch.

Droplet size measurements are well known and can be performed using a Coulter counter with the technique of resistive pulse sensing.

Weight average molecular weight is measured with gel permeation chromatography (GPC) following standard test method such as ASTM D6474-20 and documents cited therein.

The details of one or more embodiments of the invention are set forth in the description below. Other features, objects, and advantages of the invention will be apparent from the description and the claims.

### DETAILED DESCRIPTION OF THE INVENTION

Many flavoring compounds in beverage preparation are essential oils such as orange, lemon, and grapefruit, which have limited water solubility. Flavor emulsions are of increasing interest in the beverage industry for improved taste experience and additional wellness benefits. Desirable flavor emulsions have a mean particle size of 1 micron or less.

This invention relates to a robust oil-in-water emulsion that allows delivering a broader palette of flavor ingredients (e.g., citrus and non-citrus flavor tonality) as well as other ingredients such as colors, modulators such steviol and/or non-steviol based sweetness enhancers, etc. The emulsion is based on an emulsifier system containing an octenyl succinic anhydride (OSA)-modified food starch with a weight average molecular weight of 60,000 Dalton or less, or 35,000 Dalton or less, preferably 25,000 Dalton or less, and more preferably 3,000 Dalton or less. Because weight average molecular weight measurements can vary depending on the pH used during GPC testing, in some embodiments, the OSA-modified food starch has a weight average molecular weight below 3,000 Dalton when measured by GPC at pH 2.0. In other embodiments, the OSA-modified food starch has a weight average molecular weight below 25,000 Dalton when measured by GPC at pH 3.5. And in still other embodiments, the OSA-modified food starch has a weight average molecular weight of below 35,000 when measured by GPC at pH 4.0. In some embodiments, the OSA-modified food starch has a weight average molecular weight of below 60,000 when measured by GPC at pH 4.5. The oil-in-water emulsion demonstrates are surprisingly stable and compatible with a broad range of functional ingredients, as compared to emulsions prepared with natural and/or synthetic emulsifiers such as gum acacia, lecithin, polyethoxylated sorbitan fatty acid esters, and modified food starches.

The oil-in-water emulsion is typically in the form of a liquid oil-in-water emulsion and can also be in the form of a dry emulsion. The end use applications include still and carbonated ready-to-drink, alcoholic and non-alcoholic drinks, beverage concentrate, etc. The ready-to-drink products may be acidic (pH 2.5-4.5), with a sugar content from full sugar (9-12° Brix) to reduced sugar/low calorie (less than 9° Brix), and also with no sugar/zero calorie (0° Brix).

This oil-in-water emulsion unexpectedly stabilizes taste modulator compounds, which is present in the emulsion at a level of 3 wt % or less, preferably 2% or less with a shelf life of at least one year. The functional ingredient system can be dispersed or solubilized in the aqueous phase prior to the high-pressure homogenization in the emulsion process. Optionally, certain compounds in the functional ingredient system are dispersed or solubilized in the emulsion after the high-pressure homogenization process. The liposoluble phase is 0.5 wt % to 30 wt %, preferably 0.5% to 20 wt % of the oil-in-water emulsion. The mean oil droplet size of the emulsion is typically 1 micro or less (e.g., 0.8 microns or less and 0.6 microns or less) with a droplet size distribution from 0.1 microns to 1.2 microns. This emulsifying system is stable in the acidic ready-to-drink beverages (pH 2.5-4.5) either in presence or absence of natural sweeteners such as sugars or stevia-based compounds and synthetic sweeteners such as aspartame, or a combination thereof.

Suitable flavor compounds may be chosen from synthetic flavors, flavoring oils and oil extracts derived from plants, leaves, flowers, fruits, and combinations thereof.

Ingredients of the functional ingredient system can also include nutraceutical compounds such as cannabidiol (CBD), vitamins such as vitamin E, sweeteners as part of taste modulators such as steviol and/or non-steviol based compounds, colorants such as Yellow 5 or Red 40, or a combination thereof. Additionally, the functional ingredient system may optionally contain one or more preservatives, acidulants, antioxidants, juices, extracts, or a combination thereof. Functional ingredients are either water-soluble or oil-soluble.

Accordingly, the oil-in-water emulsions of this invention each have a plurality of oil droplets, a continuous aqueous phase, an emulsifier system, and, optionally, a defoamer.

The oil droplets are normally hydrophobic and immiscible with water. They contain one or more active materials selected from flavors, oil-soluble vitamins, oil-soluble colorants, antioxidants, taste modulators, mouthfeel modulators, oil-soluble defoamer, and any combinations thereof. Useful taste modulators include acid maskers, polyaldo matric, beer hops, cooling agents, hot tasting substances, sweet enhancers, salt enhancers, salivation-inducing substances, substances causing a warmth or tingling feeling, and any combinations thereof. Exemplary mouthfeel modulators are coconut oil, coconut milk with or without sugar, vanillin, stevia glycosides such as Rebaudiosides A, C, D, E, and F, medium chain tryglycerides, steviol, glucosylated stevia glycosides, and combinations thereof.

Other suitable active materials include fragrances, pro-fragrances, malodor counteractive agents, anti-inflammatory agents, fungicides, anesthetics, analgesics, antimicrobial actives, anti-viral agents, anti-infectious agents, anti-acne agents, skin lightening agents, insect repellants, emollients, skin moisturizing agents, wrinkle control agents, UV protection agents, fabric softener actives, hard surface cleaning actives, skin or hair conditioning agents, insect repellants, animal repellents, vermin repellents, flame retardants, antistatic agents, nanometer size inorganic solids, polymeric or elastomeric particles, and any combinations thereof.

Other than the active materials, the oil droplets can also contain adjunct materials such as viscosity modifiers and pH modifiers. The active materials and the adjunct materials are described below in more details.

When the oil droplets contain a flavor, the flavor is present at a level of 0.1 to 20% (e.g., 0.2 to 15% and 0.5 to 10%) by weight of the emulsion.

The oil droplets each have a droplet size of 2 microns or below, e.g., 1 micron or below, 0.8 microns or below, 0.1 to 1.2 microns, 0.1 to 1 micron, and 0.2 to 0.6 microns.

The oil droplets are dispersed in the aqueous phase that contains water or optionally a co-solvent. The co-solvent is added to improve the solubility of the emulsifier system in water and also the stability of the emulsion. Exemplary co-solvents are polyols selected from the group consisting of propylene glycol, 1,3-propandiol, glycerin, butylene glycol, erythritol, xylitol, mannitol, sorbitol, isomalt, or a combination thereof. The co-solvent, when present, constitutes 5 to 25% (e.g., 5 to 20%), glycerin is present at a level of 0.1 to 35% (e.g., 5 to 30%), and sorbitol is present at a level of 25 to 65% (e.g., 30 to 50%), all by weight of the flavor emulsion.

The emulsifier system is contained in the oil phase, the aqueous phase, or both. It is present at a level of 0.1 to 30% (e.g., 0.2 to 25%, 0.3 to 20%, and 0.5 to 15%) by weight of the emulsion.

Co-emulsifiers include polyethoxylated sorbitan fatty acid esters such as polyoxyethylene sorbitan monolaurate, polyoxyethylene sorbitan monopalmitate, polyoxyethylene sorbitan monostearate, and polyoxyethylene sorbitan monooleate; lecithins such as native, deoiled, fractionated, or enzyme-modified (lysolecithin) lecithins; food safe such as ammonium phosphatides, mono- or diglycerides of fatty acids including distilled monoglycerides, acetic acid esters of mono- and diglycerides (Acetem), lactic acid esters of mono- and diglycerides of fatty acids (Lactem), citric acid esters of mono and diglycerides of fatty acids (Citrem), mono and diacetyl tartaric acid esters of mono and diglycerides of fatty acids (Datem), succinic acid esters of monoglycerides of fatty acids (SMG), ethoxylated monoglycerides, sucrose esters of fatty acids, sucroglycerides, polyglycerol esters of fatty acids, polyglycerol polyricinoleate, propane-1,2 diol esters of fatty acids, thermally oxidized soya bean oil interacted with mono- or diglycerides of fatty acids, sodium stearoyl lactylate (SSL), calcium stearoyl lactylate (CSL), stearyl tartrate, sorbitan esters of fatty acids, polyglycerol esters of interesterified castor oil acid (E476), sodium stearoyllatylate, sodium lauryl sulfate, polyoxyethylated hydrogenated castor oil (for instance, such sold under the trade name CREMO-PHOR), block copolymers of ethylene oxide and propylene oxide (for instance as sold under the trade name PLURONIC or the trade name POLOXAMER), polyoxyethylene fatty alcohol ethers, and polyoxyethylene stearic acid ester, etc. Examples of sorbitan esters of fatty acids are sorbitan monostearate, sorbitan tristearate, sorbitan monolaurate, sorbitan monooleate, sorbitan monopalmitate, and saccharose esters of fatty acids.

Optionally, the flavor emulsion contains a defoamer, which can be a water-dispersible defoamer or oil-soluble defoamer. Examples include silicone emulsion antifoamers, polydimethylsiloxane antifoamers, 2-octanol, petrolatum, hop lipids, alginates, mineral oil, sobitan monostearate, and a combination thereof.

The emulsions described above can be added to an alcoholic or non-alcoholic, carbonated or non-carbonated beverage base solution to enhance the flavor, taste, or mouthfeel of the beverage.

In certain embodiments, the flavor emulsion further contains, in the aqueous phase, 0.01% to 20% a carrier material including mono- and di-saccharide sugars such as glucose, lactose, levulose, trehalose, fructose, maltose, ribose, sucrose, or a combination thereof. In other embodiments, the aqueous phase further contains a protein, gum, and/or hydrocolloid. Suitable proteins include soy protein isolate, soy protein concentrate, whey protein isolate, whey protein concentrate, gelatin, pea protein, and protein hydrolysates. Example of gums and hydrocolloids include xanthan gum, guar gum, gum acaia, chemically modified gum acaia, pectin, and alginate.

Flavor emulsions of the present invention are prepared by emulsifying the flavor oil into the aqueous phase in the presence of the OSA-modified starch using conventional techniques. Briefly, emulsions are typically prepared by mixing the aqueous and oil phases, and subjecting the mixture to homogenization several times, or, in the terminology of the art, to make more than one “pass.” In accordance with the present invention, a pre-emulsion step (i.e., a high shear mixing step) is critical to set the initial particle size prior to high-pressure homogenization. The speed of high shear mixing may range from 3,000 rpm to 20,000 rpm and the time of mixing may range from 5 to 30 minutes. A high-pressure homogenizer (e.g., commercially available Niro Panda 2000) or other type of homogenizer (e.g., MICROFLUIDIZER commercially available from Microfluidics or EMULSIFLEX commercially available from Avestin) is subsequently used to prepare the emulsion. Homogenization can be carried out at 2,000 psi or greater, preferably 3,000 psi or greater, for one, two, or more passes. It can also be carried out at 3,000/300 psi to 10,000/1,000 psi or 6,500/500 psi to 20,000/2,000 psi using a two-stage homogenizer for two, three, or more passes.

The oil-in-water emulsion can be used in a variety of consumer, food, or pharmaceutical products. In particular, the flavor emulsion finds application in beverages, gums, confections, oral care products, snacks, dairy products, soups, sauces, and condiments.

In specific embodiments, the oil-in-water emulsion is used in beverages and beverage liquid concentrates. Accordingly, in addition to flavor emulsions, the present invention also provides final beverage products or liquid beverage concentrates containing the oil-in-water emulsion of the invention.

In some embodiments, the oil-in-water emulsion is dosed at a level between 1 ppm to 60% (e.g., 1 ppm to 20%, 5 ppm to 5%, and 10 ppm to 1%) by weight of the final beverage product so that the product contains a flavor oil 0.01 ppm to 10% (0.1 ppm to 5%, 0.5 ppm to 1%, and 1 ppm to 100 ppm). In particular embodiments, the final beverage product is clear, having a turbidity of 10 NTU (e.g., 5 NTU and 3 NTU) or below.

As used herein, the term “liquid beverage concentrate” means a liquid composition that can be diluted with another liquid, such as an aqueous, potable liquid to provide a final beverage or added to a food product prior to being consumed. The phrase “liquid” refers to a non-gaseous, flowable, fluid composition at room temperature (i.e., 70° F.). The term “final beverage” as used herein means a beverage that has been prepared either by the standard soft drink (i.e., ready-to-drink) preparation procedure or by diluting the concentrate to provide a beverage in a potable, consumable form. In some aspects, the concentrate is non-potable due to acidulant content and/or flavor intensity. By way of example to clarify the term “concentration,” a concentration of 75 times (i.e., “75×”) would be equivalent to 1 part concentrate to 74 parts water (or other potable liquid) to provide the final beverage. In other words, the flavor profile of the final beverage is taken into account when determining an appropriate level of dilution, and thus concentration, of the liquid beverage concentrate. The dilution factor of the concentrate can also be expressed as the amount necessary to provide a single serving of concentrate.

The viscosity, pH, and formulations of the concentrates will depend, at least in part, on the intended dilution factor. In one approach, a moderately concentrated product may be formulated to be diluted by a factor of at least 5 times to provide a final beverage, which can be, for example, an 8 ounce beverage. In one aspect, the concentrate is formulated to be diluted by a factor of 5 to 15 times to provide a final beverage. In this form, the liquid concentrate has a pH of 2.5 to 4.5; and a viscosity of 7.5 to 100 cP, 10 to 100 cP, 15 to 100 cP, 10 to 50 cP, or 10 to 20 cP, as measured using Spindle S00 at 50 rpm and 20° C. with a Brookfield DVII+Pro Viscometer. In some embodiments, the concentrate includes at least 0.1 to 15 percent acidulant by weight of the concentrate. Any edible, food grade organic or inorganic acid, such as, but not limited to, citric acid, malic acid, succinic acid, acetic acid, hydrochloric acid, adipic acid, tartaric acid, fumaric acid, phosphoric acid, lactic acid, sodium acid pyrophosphate, salts thereof, and combinations thereof can be used, if desired. The selection of the acidulant may depend, at least in part, on the desired pH of the concentrate and/or taste imparted by the acidulant to the diluted final beverage. In another aspect, the amount of acidulant included in the concentrate may depend on the strength of the acid. For example, a larger quantity of lactic acid would be needed in the concentrate to reduce the pH in the final beverage than a stronger acid, such as phosphoric acid. In some embodiments, a buffer can be added to the concentrate to provide for increased acid content at a desired pH. Suitable buffers include, for example, a conjugated base of an acid, gluconate, acetate, phosphate or any salt of an acid (e.g., sodium citrate and potassium citrate). In other instances, an undissociated salt of the acid can buffer the concentrate.

The beverages or concentrates of the invention can include one or more juices or juice concentrates (such as at least a 4× concentrated product) from fruits or vegetables for bulk solid addition. In one aspect, the juice or juice concentrate may include, for example, coconut juice (also commonly referred to as coconut water), apple, pear, grape, orange, potato, tangerine, lemon, lime, tomato, carrot, beet, asparagus, celery, kale, spinach, pumpkin, strawberry, raspberry, banana, blueberry, mango, passionfruit, peach, plum, papaya, and combinations. The juice or juice concentrates may also be added as a puree, if desired.

As indicated, concentrates can be added to potable liquids to form flavored beverages. In some aspects, the concentrate may be non-potable (such as due to the high acid content and intensity of flavor). For example, the beverage concentrate can be used to provide flavor to water, cola, carbonated water, tea, coffee, seltzer, club soda, the like, and can also be used to enhance the flavor of juice. In one embodiment, the beverage concentrate can be used to provide flavor to alcoholic beverages, including but not limited to flavored champagne, sparkling wine, wine spritzer, cocktail, martini, or the like. In particular embodiments, the concentrate is used in an optically clear beverage.

Beverage concentrates can also be combined with a variety of food products to add flavor to the food products. For example, concentrates can be used to provide flavor to a variety of solid, semi-solid, and liquid food products, including but not limited to oatmeal, cereal, yogurt, strained yogurt, cottage cheese, cream cheese, frosting, salad dressing, sauce, and desserts such as ice cream, sherbet, sorbet, and Italian ice. Appropriate ratios of the beverage concentrate to food product or beverage can readily be determined by one of ordinary skill in the art.

For the purpose of this invention, stability is defined as a flavor quality and intensity that remains acceptable for use in end use applications. Preferably, a stable emulsion has a shelf-life of at least 1 year to three years depending on storage conditions.

Flavor oils suitable for preparing the emulsions of this invention contain one or more volatile and nonvolatile compounds. A variety of flavors can be used in accordance with the present invention. Flavors may be chosen from synthetic flavors, flavoring oils and oil extracts derived from plants, leaves, flowers, fruits, and combinations thereof. Representative flavor oils include, but are not limited to, spearmint oil, cinnamon oil, peppermint oil, clove oil, bay oil, thyme oil, cedar leaf oil, oil of nutmeg, oil of sage, and oil of bitter almonds. Also useful are artificial, natural or synthetic fruit flavors such as vanilla, chocolate, coffee, cocoa and citrus oil, including lemon, orange, grape, lime and grapefruit, and fruit essences including apple, pear, peach, strawberry, watermelon, raspberry, cherry, plum, pineapple, apricot and so forth. These flavors can be used individually or in admixture.

Volatile compounds in the flavor oils may include, but are not limited to, acetaldehyde, dimethyl sulfide, ethyl acetate, ethyl propionate, methyl butyrate, and ethyl butyrate. Flavors containing volatile aldehydes or esters include, e.g., cinnamyl acetate, cinnamaldehyde, citral, diethylacetal, dihydrocarvyl acetate, eugenyl formate, and p-methylanisole. Further examples of volatile compounds that may be present in the flavor oils include acetaldehyde (apple); benzaldehyde (cherry, almond); cinnamic aldehyde (cinnamon); citral, i.e., alpha citral (lemon, lime); neral, i.e., beta citral (lemon, lime); decanal (orange, lemon); ethyl vanillin (vanilla, cream); heliotropine, i.e., piperonal (vanilla, cream); vanillin (vanilla, cream); alpha-amyl cinnamaldehyde (spicy fruity flavors); butyraldehyde (butter, cheese); valeraldehyde (butter, cheese); citronellal (modifies, many types); decanal (citrus fruits); aldehyde C-8 (citrus fruits); aldehyde C-9 (citrus fruits); aldehyde C-12 (citrus fruits); 2-ethyl butyraldehyde (berry fruits); hexenal, i.e., trans-2 (berry fruits); tolyl aldehyde (cherry, almond); veratraldehyde (vanilla); 2,6-dimethyl-5-heptenal, i.e., melonal (melon); 2-6-dimethyloctanal (green fruit); and 2-dodecenal (citrus, mandarin); cherry; or grape and mixtures thereof. The composition may also contain taste modulators and artificial sweeteners.

The flavor emulsion can contain the following active materials:

(i) taste masking agents, substances for masking one or more unpleasant taste sensations, in particular a bitter, astringent and/or metallic taste sensation or aftertaste. Examples include lactisol [2O-(4-methoxyphenyl) lactic acid] (cf. U.S. Pat. No. 5,045,336), 2,4-dihydroxybenzoic acid potassium salt (cf. U.S. Pat. No. 5,643,941), ginger extracts (cf. GB 2,380,936), neohesperidine dihydrochalcone (cf. Manufacturing Chemist 2000, July issue, p. 16-17), specific flavones (2-phenylchrom-2-en-4-ones) (cf. U.S. Pat. No. 5,580,545), specific nucleotides, for example cytidine-5′-monophosphates (CMP) (cf. US 2002/0177576), specific sodium salts, such as sodium chloride, sodium citrate, sodium acetate and sodium lactate (cf. Nature, 1997, Vol. 387, p. 563), a lipoprotein of .beta.-lactoglobulin and phosphatidic acid (cf. EPA 635 218), neodiosmine [5,7-dihydroxy-2-(4-methoxy-3-hydroxyphenyl)-7-O-neohesperidosyl-chrom-2-en-4-one] (cf. U.S. Pat. No. 4,154,862), preferably hydroxyflavanones according to EP 1 258 200, in turn preferred in this respect 2-(4-hydroxyphenyl)-5,7-dihydroxychroman-4-one (naringenin), 2-(3,4-dihydroxyphenyl)-5,7-dihydroxychroman-4-one (eriodictyol), 2-(3,4-dihydroxyphenyl)-5-hydroxy-7-methoxychroman-4-one (eriodictyol-7-methylether), 2-(3,4-dihydroxyphenyl)-7-hydroxy-5-methoxychroman-4-one (eriodictyol-5-methylether) and 2-(4-hydroxy-3-methoxyphenyl)-5,7-dihydroxychroman-4-one (homoeriodictyol), the (2S)- or (2R)-enantiomers thereof or mixtures thereof as well as the mono- or polyvalent phenolate salts thereof with Na⁺, K⁺, NH4⁺, Ca²⁺, Mg²⁺ or Al³⁺ as counter cations or .gamma.-aminobutyric acid (4-aminobutyric acid, as the neutral form (“inner salt”) or in the carboxylate or ammonium form) according to WO 2005/09684;

(ii) taste sensates including hot tasting, salivation-inducing substances, substances causing a warmth or tingling feeling, and cooling active ingredients. Examples of hot tasting and/or salivation-inducing substances and/or substances which cause a feeling of warmth and/or a tingling feeling on the skin or on the mucous membranes and which can be a constituent of the products according to the invention are: capsaicin, dihydrocapsaicin, gingerol, paradol, shogaol, piperine, carboxylic acid-N-vanillylamides, in particular nonanoic acid-N-vanillylamide, pellitorin or spilanthol, 2-nonanoic acid amides, in particular 2-nonanoic acid-N-isobutylamide, 2-nonanoic acid-N-4-hydroxy-3-methoxyphenylamide, alkyl ethers of 4-hydroxy-3-methoxybenzyl alcohol, in particular 4-hydroxy-3-methoxybenzyl-n-butylether, alkyl ethers of 4-acyloxy-3-methoxybenzyl alcohol, in particular 4-acetyloxy-3-methoxybenzyl-n-butylether and 4-acetyloxy-3-methoxybenzyl-n-hexylether, alkyl ethers of 3-hydroxy-4-methoxybenzyl alcohol, alkyl ethers of 3,4-dimethoxybenzyl alcohol, alkyl ethers of 3-ethoxy-4-hydroxybenzyl alcohol, alkyl ethers of 3,4-methylene dioxybenzyl alcohol, (4-hydroxy-3-methoxyphenyl)acetic acid amides, in particular (4-hydroxy-3-methoxyphenyl)acetic acid-N-n-octylamide, vanillomandelic acid alkylamides, ferulic acid-phenethylamides, nicotinaldehyde, methylnicotinate, propylnicotinate, 2-butoxyethylnicotinate, benzylnicotinate, 1-acetoxychavicol, polygodial and isodrimeninol, further preferred cis- and/or trans-pellitorin according to WO 2004/000787 or WO 2004/043906, alkenecarboxylic acid-N-alkylamides according to WO 2005/044778, mandelic acid alkylamides according to WO 03/106404 or alkyloxyalkanoic acid amides according to WO 2006/003210. Examples of preferred hot tasting natural extracts and/or natural extracts which cause a feeling of warmth and/or a tingling feeling on the skin or on the mucous membranes and which can be a constituent of the products according to the invention are: extracts of paprika, extracts of pepper (for example capsicum extract), extracts of chili pepper, extracts of ginger roots, extracts of Aframomum melgueta, extracts of Spilanthes-acmella, extracts of Kaempferia galangal or extracts of Alpinia galanga. Suitable cooling active ingredients include the following: 1-menthol, d-menthol, racemic menthol, menthone glycerol acetal (trade name: Frescolat®MGA), menthyl lactate (trade name: Frescolat®ML, menthyl lactate preferably being 1-menthyl lactate, in particular 1-menthyl-1-lactate), substituted menthyl-3-carboxamides (for example menthyl-3-carboxylic acid-N-ethylamide), 2-isopropyl-N-2,3-trimethyl-butanamide, substituted cyclohexane carboxamides, 3-menthoxypropane-1,2-diol, 2-hydroxyethyl menthyl carbonate, 2-hydroxypropyl menthyl carbonate, N-acetylglycine menthyl ester, isopulegol, hydroxycarboxylic acid menthyl esters (for example menthyl-3-hydroxybutyrate), monomenthyl succinate, 2-mercaptocyclodecanone, menthyl-2-pyrrolidin-5-onecarboxylate, 2,3-dihydroxy-p-menthane, 3,3,5-trimethylcyclohexanone glycerol ketal, 3-menthyl-3,6-di- and -trioxaalkanoates, 3-menthyl methoxyacetate and icilin. Cooling active ingredients which are particularly preferred are as follows: 1-menthol, racemic menthol, menthone glycerol acetal (trade name: Frescolat®MGA), menthyl lactate (preferably 1-menthyl lactate, in particular 1-menthyl-1-lactate, trade name: Frescolat®ML), 3-menthoxypropane-1,2-diol, 2-hydroxyethyl menthyl carbonate, 2-hydroxypropyl menthyl carbonate.

(iii) vitamins including any vitamin, a derivative thereof and a salt thereof. Examples are as follows: vitamin A and its analogs and derivatives (e.g., retinol, retinal, retinyl palmitate, retinoic acid, tretinoin, and iso-tretinoin, known collectively as retinoids), vitamin E (tocopherol and its derivatives), vitamin C (L-ascorbic acid and its esters and other derivatives), vitamin B3 (niacinamide and its derivatives), alpha hydroxy acids (such as glycolic acid, lactic acid, tartaric acid, malic acid, citric acid, etc.) and beta hydroxy acids (such as salicylic acid and the like);

(iv) antibacterials including bisguanidines (e.g., chlorhexidine digluconate), diphenyl compounds, benzyl alcohols, trihalocarbanilides, quaternary ammonium compounds, ethoxylated phenols, and phenolic compounds, such as halo-substituted phenolic compounds, like PCMX (i.e., p-chloro-m-xylenol), triclosan (i.e., 2,4,4′-trichloro-2′ hydroxy-diphenylether), thymol, and triclocarban;

(v) antioxidants such as beta-carotene, vitamin C (Ascorbic Acid) or an ester thereof, vitamin A or an ester thereof, vitamin E or an ester thereof, lutein or an ester thereof, lignan, lycopene, selenium, flavonoids, vitamin-like antioxidants such as coenzyme Q10 (CoQ10) and glutathione, and antioxidant enzymes such as superoxide dismutase (SOD), catalase, and glutathione peroxidase;

(vi) anti-inflammatory agents including, e.g., methyl salicylate, aspirin, ibuprofen, and naproxen. Additional anti-inflammatories useful in topical applications include corticosteroids, such as, but not limited to, flurandrenolide, clobetasol propionate, halobetasol propionate, fluticasone propionate, betamethasone dipropionate, betamethasone benzoate, betamethasone valerate, desoximethasone, dexamethasone, diflorasone diacetate, mometasone furoate, amcinodine, halcinonide, fluocinonide, fluocinolone acetonide, desonide, triamcinolone acetonide, hydrocortisone, hydrocortisone acetate, fluoromethalone, methylprednisolone, and predinicarbate;

(vii) anesthetics that can be delivered locally including benzocaine, butamben, butamben picrate, cocaine, procaine, tetracaine, lidocaine and pramoxine hydrochloride;

(viii) analgesics such as ibuprofen, diclofenac, capsaicin, and lidocaine;

(ix) antifungal agents. Non-limiting examples are micanazole, clotrimazole, butoconazole, fenticonasole, tioconazole, terconazole, sulconazole, fluconazole, haloprogin, ketonazole, ketoconazole, oxinazole, econazole, itraconazole, torbinafine, nystatin and griseofulvin;

(x) antibiotics such as erythromycin, clindamycin, synthomycin, tetracycline, metronidazole and the like;

(xi) anti-viral agents including famcyclovir, valacyclovir and acyclovir;

(xii) anti-parasitic agents such as scabicedes, such as permethrin, crotamiton, lindane and ivermectin;

(xiii) anti-infectious and anti-acne agents including benzoyl peroxide, sulfur, resorcinol and salicylic acid;

(xiv) enzymes and co-enzymes including co-enzyme Q10, papain enzyme, lipases, proteases, superoxide dismutase, fibrinolysin, desoxyribonuclease, trypsin, collagenase and sutilains;

(xv) anti-histamines including chlorpheniramine, brompheniramine, dexchlorpheniramine, tripolidine, clemastine, diphenhydramine, prometazine, piperazines, piperidines, astemizole, loratadine and terfonadine;

(xvi) chemotherapeutic agents such as 5-fluorouracil, masoprocol, mechlorethamine, cyclophosphamide, vincristine, chlorambucil, streptozocin, methotrexate, bleomycin, dactinomycin, daunorubicin, coxorubicin and tamoxifen; and

In addition to the active materials listed above, the products of this invention can also contain, for example, the following dyes, colorants or pigments: lactoflavin (riboflavin), beta-carotene, riboflavin-5′-phosphate, alpha-carotene, gamma-carotene, cantaxanthin, erythrosine, curcumin, quinoline yellow, yellow orange S, tartrazine, bixin, norbixin (annatto, orlean), capsanthin, capsorubin, lycopene, beta-apo-8′-carotenal, beta-apo-8′-carotenic acid ethyl ester, xantophylls (flavoxanthin, lutein, cryptoxanthin, rubixanthin, violaxanthin, rodoxanthin), fast carmine (carminic acid, cochineal), azorubin, cochineal red A (Ponceau 4 R), beetroot red, betanin, anthocyanins, amaranth, patent blue V, indigotine I (indigo-carmine), chlorophylls, copper compounds of chlorophylls, acid brilliant green BS (lissamine green), brilliant black BN, vegetable carbon, titanium dioxide, iron oxides and hydroxides, calcium carbonate, aluminum, silver, gold, pigment rubine BK (lithol rubine BK), methyl violet B, victoria blue R, victoria blue B, acilan brilliant blue FFR (brilliant wool blue FFR), naphthol green B, acilan fast green 10 G (alkali fast green 10 G), ceres yellow GRN, sudan blue II, ultramarine, phthalocyanine blue, phthalocayanine green, fast acid violet R. Further naturally obtained extracts (for example paprika extract, black carrot extract, red cabbage extract) can be used for coloring purposes. Goods results are also achieved with the colors named in the following, the so-called aluminum lakes: FD & C Yellow 5 Lake, FD & C Blue 2 Lake, FD & C Blue 1 Lake, Tartrazine Lake, Quinoline Yellow Lake, FD & C Yellow 6 Lake, FD & C Red 40 Lake, Sunset Yellow Lake, Carmoisine Lake, Amaranth Lake, Ponceau 4R Lake, Erythrosyne Lake, Red 2G Lake, Allura Red Lake, Patent Blue V Lake, Indigo Carmine Lake, Brilliant Blue Lake, Brown HT Lake, Black PN Lake, Green S Lake and mixtures thereof.

### Adjunct Materials

In addition to the active materials, the present invention also contemplates the incorporation of one or more adjunct materials including solvent, emollients, solubility modifiers, density modifiers, stabilizers, viscosity modifiers, pH modifiers, or any combination thereof. These modifiers can be present in the aqueous or oil phase.

The one or more adjunct material may be added in the amount of from 0.01% to 25% (e.g., from 0.5% to 10%) by weight of the flavor emulsion.

(i) Solvent. Preferable solvent materials are hydrophobic and miscible with the active materials. Solvents increase the compatibility of various active materials, increase the overall hydrophobicity of the mixture containing the active materials, influence the vapor pressure, or serve to structure the mixture. It should be noted that selecting a solvent and active material with high affinity for each other will result in improvement in stability. Exemplary solvents are triglyceride oil, mono and diglycerides, mineral oil, silicone oil, diethyl phthalate, polyalpha olefins, castor oil, isopropyl myristate, mono-, di- and tri-esters and mixtures thereof, fatty acids, and glycerine.

(ii) Triglycerides and modified triglycerides as emollients. These include vegetable oils such as jojoba, soybean, canola, sunflower, safflower, rice bran, avocado, almond, olive, sesame, persic, castor, coconut, and mink oils.

(iii) Ester oils have at least one ester group in the molecule. One type of common ester oil useful in the present invention are the fatty acid mono and polyesters such as cetyl octanoate, octyl isonanoanate, myristyl lactate, cetyl lactate, isopropyl myristate, myristyl myristate, isopropyl palmitate, isopropyl adipate, butyl stearate, decyl oleate, cholesterol isostearate, glycerol monostearate, glycerol distearate, glycerol tristearate, alkyl lactate, alkyl citrate and alkyl tartrate.

(iv) Ester oil as a liquid polyester formed from the reaction of a dicarboxylic acid and a diol. Examples of polyesters suitable for the present invention are the polyesters marketed by ExxonMobil under the trade name PURESYN ESTER′ hydrophobic plant extracts.

(v) Silicones include, for example, linear and cyclic polydimethylsiloxanes, amino-modified, alkyl, aryl, and alkylaryl silicone oil.

(vi) Low/non volatile hydrocarbons

(vii) Solubility modifiers. Nonlimiting examples of a solubility modifier include surfactants (e.g., SLS and Tween® 80), acidic compounds (e.g., mineral acids such as sulfuric acid, hydrochloric acid, nitric acid, and phosphoric acid, and carboxylic acids such as acetic acid, citric acid, gluconic acid, glucoheptonic acid, and lactic acid), basic compounds (e.g., ammonia, alkali metal and alkaline earth metal hydroxides, primary, secondary, or tertiary amines, and primary, secondary, or tertiary alkanolamines), ethyl alcohol, glycerol, glucose, galactose, inositol, mannitol, glactitol, adonitol, arabitol, and amino acids.

(viii) Density modifiers. The density of the flavor oil droplets and the flavor emulsion can be adjusted so that the emulsion has a substantially uniform distribution using known density modifiers or technologies such as those described in Patent Application Publications WO 2000/059616, EP 1 502 646, and EP 2 204 155. Suitable density modifiers include hydrophobic materials and materials having a desired molecular weight (e.g., higher than about 12,000), such as silicone oils, petrolatums, vegetable oils, especially sunflower oil and rapeseed oil, and hydrophobic solvents having a desired density (e.g., less than about 1,000 Kg/m3 at 25° C., such as limonene and octane.

(ix) Stabilizers. In some embodiments, a stabilizer (e.g., a colloidal stabilizer) is added to stabilize the emulsion. Examples of colloidal stabilizers are polyvinyl alcohol, cellulose derivatives such hydroxyethyl cellulose, polyethylene oxide, copolymers of polyethylene oxide and polyethylene or polypropylene oxide, or copolymers of acrylamide and acrylic acid.

(x) Viscosity control agents. Viscosity control agents (e.g., suspending agents), which may be polymeric or colloidal (e.g., modified cellulose polymers such as methylcellulose, hydoxyethylcellulose, hydrophobically modified hydroxyethylcellulose, and cross-linked acrylate polymers such as Carbomer®, hydrophobically modified polyethers) can be included in the flavor emulsions. Optionally, silicas, either hydrophobic or hydrophilic, can be included at a concentration from 0.01 to 20%, more preferable from 0.5 to 5%, by the weight of the flavor emulsion. Examples of hydrophobic silicas include silanols, surfaces of which are treated with halogen silanes, alkoxysilanes, silazanes, and siloxanes, such as SIPERNAT® D17, AEROSIL® R972 and R974 available from Degussa. Exemplary hydrophilic silicas are AEROSIL® 200, SIPERNAT® 22S, SIPERNAT® 50S (available from Degussa), and SYLOID® 244 (available from Grace Davison).

(xi) pH modifiers. In some embodiments, one or more pH modifiers are included in the emulsions to adjust the pH. Exemplary pH modifiers include metal hydroxides (e.g., LiOH, NaOH, KOH, and Mg(OH)₂), metal carbonates and bicarbonates (CsCO₃Li₂CO₃, K₂CO₃, NaHCO₃, and CaCO₃), metal phosphates/hydrogen phosphates/dihydrogen phosphates, metal sulfates, ammonia, mineral acids (HCl, H₂SO₄, H₃PO₄, and HNO₃), carboxylic acids (e.g., acetic acid, citric acid, malic acid, tartaric acid, succinic acid, fumaric acid, lactic acid, benzoic acid, and sulfonic acids), and amino acids.

The level of the adjunct materials can be present at a level of 0.01 to 25% (e.g., from 0.5% to 10%) or greater than 10% (e.g., greater than 30% and greater than 70%).

Other modifications of this invention will be readily apparent to those skilled in the art. Such modifications are understood to be within the scope of this invention. In addition, all parts, percentages, proportions, and ratios typically refer to herein and in the claims are by weight unless otherwise specified.

All parts, percentages and proportions refer to herein and in the claims are by weight unless otherwise indicated.

The values and dimensions disclosed herein are not to be understood as being strictly limited to the exact numerical values recited. Instead, unless otherwise specified, each such value is intended to mean both the recited value and a functionally equivalent range surrounding that value. For example, a value disclosed as “50%” is intended to mean “about 50%.”

The terms “include,” “includes,” and “including” are meant to be non-limiting.

All publications cited herein are incorporated by reference in their entirety.

The invention is described in greater detail by the following non-limiting examples.

As an illustration, oil-in-water emulsions is prepared according to the procedure described below. Briefly, the practice involves dispersing and dissolving the water-soluble/dispersible dry materials (e.g., preservatives, acidulants, sugars, hydrocolloids, nutraceuticals, taste modulators among other functional ingredients, flavor compounds, and emulsifiers/co-emulsifiers) in water until free of lumps. In a similar fashion, the oil phase is prepared by mixing together the oil-soluble flavor compounds, essential oils, solvents and other oil-soluble functional ingredients until completely homogeneous. Then the oil phase is added to the water phase under constant agitation until uniformed mixture is obtained. A pre-emulsion is prepared by subjecting the oil dispersed solution to high-shear mixing until a mean droplet size of 5 μm or below is achieved. The pre-emulsion is subsequently processed through high-pressure homogenization to obtain a homogeneous final emulsion.

The emulsion typically contains 50% or more of water. This may be adjusted by using less or more water depending on the solubility of the dry materials, concentration of the oil phase, and various factors related to the efficient operation of the high-shear mixer and high-pressure homogenizer. Emulsions were fabricated using the standard process conditions as shown in Table 1. In Examples below, a batch size of 1000 grams was formulated for each oil-in-water emulsion.

TABLE 1
Operating conditions for fabricating flavor emulsions

| | | High-pressure |
|---|---|---|
| | High-shear Mixing | Homogenization |
| Equipment type | SILVERSON L4RT | APV GAULIN |
| Mixing speed (rpm) | 3000 | |
| Mixing time (minute) | 4 | |
| 1st stage pressure (psi) | | 3500 |
| 2^{nd} stage pressure (psi) | | 500 |
| Number of pass | | 3 |

### Example 1

A flavor emulsion of this invention, i.e., Emulsion I, was prepared with the composition as shown in Table 2, using an OSA-modified starch, commercially available under the trade name of PURITY GUM® 2000 with a weight average molecular weight (Mw) of 1600 Dalton. Comparative Emulsions I′, II′, III′ and IV″ were prepared following the same procedure as Emulsion I, except that OSA-modified starch PURITY GUM® 2000 was replaced with modified starch under the trade name of EmulTru™ (Mw 51,400 Dalton, Cargill Inc., Minneapolis, Minn.), PURITY GUM® 1773 (Mw 14,800 Dalton, Ingredion Inc., Bridgewater, N.J.), PURITY GUM® BE (Mw 62,400 Dalton, Ingredion Inc., Bridgewater, N.J.), and PURITY GUM® Ultra (336,700 Dalton, Ingredion Inc., Bridgewater, N.J.), respectively. The weight average molecular weights were all measured by GPC at pH 2.0.

Steviol-based compounds functioning as taste modulators and the oil phase of the flavor emulsions were added at a dosage of 7.6 grams and 125 grams, respectively. The oil phase contained 70 grams of orange flavor (International Flavors and Frances, New York, N.Y.) and 55 grams of Ester Gum (Eastman Chemical Company, Kingsport, Tenn.).

TABLE 2
Compositions (in grams) of Emulsion I and Comparative I′ to IV′

| Component | I | I′ | II′ | III′ | IV′ |
|---|---|---|---|---|---|
| Water | 731.6 | 731.6 | 731.6 | 731.6 | 819.6 |
| PURITY GUM ® 2000 | 130 | | | | |
| EmulTru ™ 12674 | | 130 | | | |
| PURITY GUM ® 1773 | | | 130 | | |
| PURITY GUM ® BE | | | | 130 | |
| PURITY GUM ® Ultra | | | | | 42 |
| Citric acid | 2.5 | 2.5 | 2.5 | 2.5 | 2.5 |
| Steviol-based compounds | 7.6 | 7.6 | 7.6 | 7.6 | 7.6 |

### Weight Average Molecular Weight

The weight average molecular weight of each modified starch was measured using an Agilent 1200 gel permeation chromatography (GPC) system under the following conditions.

Column: Agilent 2*PL aquagel-OH MIXED-H 7.5*300 mm (PL2080-0700)

Column Temperature: 40° C.

Calibrants: Agilent EasiVial PEG/PEO (Part No. PL2080-0201)

Sample Concentration: 0.2% w/v

Eluent: 0.5M NaNO₃+0.01M NaH₂PO₄, use HCl solution adjusted to pH 2

Injection volume: 50 μL

Flow rate: 1 mL/min

Isocratic run time: 30 min

Detector: RI

RI optical unit Temperature: 30° C.

Solvent for the standard and the sample: Eluent pH 2 solution

Data analysis: Agilent Cirrus GPC software.

### Stability and Droplet Size

Physical stability of the flavor emulsion of this invention, i.e., Emulsion I, at time zero and after storage for 4 weeks at 40° C. was compared with that of Emulsion I′, Emulsion II′, Emulsion III′, and Emulsion IV′ as shown in Table 3. Oil droplet size of the emulsions was measured using a Coulter Counter Model LS 13 320 particle size analyzer (Beckman Coulter Life Sciences, Indianapolis, Ind.). Comparisons of the oil droplet size (Mean and D97 values) measurement performed for the emulsions at time zero and after an accelerated storage for 1 day at 57° C. are also shown in Table 3. D97 is the oil droplet size where 97% of the total droplet population is smaller than that value.

TABLE 3
Stability of Emulsion I and Comparative I′ to IV′

| | | | Oil droplet size: | | Oil droplet size: | |
|---|---|---|---|---|---|---|
| | Physical stability | | Mean (micron) | | D97 (micron) | |
| Emulsion | Time 0 | 4 weeks | Time 0 | 1 day | Time 0 | 1 day |
| I | Homogenous | Homogenous | 0.1 | 0.2 | 0.2 | 0.7 |
| I′ | Homogenous | Creamed | 0.1 | 0.4 | 0.4 | 1.6 |
| II′ | Homogenous | Creamed | 0.1 | 0.3 | 0.2 | 1.7 |
| III′ | Homogenous | Creamed | 0.1 | 0.3 | 0.4 | 2.1 |
| IV′ | Oiling off, | Oiling off, | N/A | N/A | N/A | N/A |
| | Phase | Phase | | | | |
| | separation | separation | | | | |

As shown in Table 3 above, Emulsion I of this invention, unexpectedly, shows a superior physical stability and oil droplet size stability than the comparatives.

Additional comparative oil-in-water emulsions were prepared using gum acacia under the trade names of Instantgum™ AA, Eficacia™ XE, and SuperStab™, all commercially available from Nexira Inc., Somerville, N.J. Those comparative emulsions were unstable after stored at 40° C. for 4 weeks. Each showed oiling off and phase separation, rending it unsuitable to deliver the taste enhancer compounds.

### Examples 2-5

A flavor emulsion of this invention, i.e., Emulsion II, was prepared following the same procedure of Emulsion I except that the level of steviol-based compounds in the composition was increased from 7.6 grams to 20 grams. Emulsion III, Emulsion IV, Emulsion V of this invention were prepared following the same procedure except that the aqueous phase further contained maltose and a co-emulsifier, i.e., a modified starch commercially available under the tradename of CAPSUL®, Ingredion Inc, Bridgewater, N.J. See Table 4 below for compositions.

TABLE 4
Compositions (in gram) of Emulsions II to V.

| Component | II | III | IV | V |
|---|---|---|---|---|
| Water | 719.2 | 623.2 | 620.7 | 602.7 |
| PURITY GUM ® 2000 | 130 | 130 | 130 | 130 |
| CAPSUL ® | | 65 | 65 | 100 |
| Maltose | | 31 | 31 | 14 |
| Citric acid | 2.5 | 2.5 | 5 | 5 |
| Steviol-based compounds | 20 | 20 | 20 | 20 |

### Examples 6-7

Two more emulsions, VI and VII, were prepared using the ingredients in Table 5 below and the procedure described below.

The emulsion composition is comprised of (weight percentage):

TABLE 5
Compositions (wt %) of Emulsions VI and VII.

| | | |
|---|---|---|
| Ingredient | VI | VII |

AQUEOUS PHASE

| | | |
|---|---|---|
| Water | 73.8% | 62.2% |
| Citrus acid (acidulant) | 0.25% | 0.5% |
| Potassium sorbate (preservative) | 0.15% | 0.15% |
| Sodium benzoate (preservative) | 0.15% | 0.15% |
| Maltose (carbohydrate) | | 1.4% |
| taste modulator | 1% | 2% |
| Purity Gum ® 2000 (emulsifier) | 13% | 13% |
| CAPSUL ® (co-emulsifier) | | 10% |

OIL PHASE

| | | |
|---|---|---|
| Flavor oil | 7% | 7% |
| Ester gum (weighing agent) | 5.5% | 5.5% |
| Rosemary extract and tocopherols (antioxidant) | 0.03% | 0.03% |

The emulsion process steps included:
(a) preparing an aqueous solution by solubilizing water-soluble functional ingredients such as citric acid, preservatives, steviol-based or non-steviol-based compounds, optionally with other ingredients such as maltose, carbohydrates and water-soluble solvents,
(b) mixing an OSA modified food starch (e.g., PURITY GUM® 2000), optionally with other co-emulsifiers (e.g., CAPSUL®), into the solution until fully dissolved,
(c) preparing an oil phase containing flavor, optionally combined with other oil-soluble ingredients including but not limited to cannabidiol (CBD), medium chain triglyceride (MCT), plant-based oil, weighting agent, antioxidant, colorants, vitamins, or the combination thereof,
(d) emulsifying the oil phase into the aqueous phase to form a pre-emulsion at a low speed admixing (Silverson high-speed mixer operated at 6500 rpm) followed by high-pressure homogenization (GAULIN homogenizer operated at 3500/500 psi) for multiple passes, e.g., 2 times or above, to create the oil-in-water emulsion, and
(e) Optionally, adding water-soluble functional ingredients into the emulsion of step (d) until uniformed (“post homogenization addition”).

### Example 8

A beverage of this invention, i.e., Beverage A, was prepared following the procedure described below. More specifically, 0.1% (wt/vol) of Emulsion I was mixed with a non-alcoholic beverage solution, which was prepared with the formulation shown in TABLE 6. Beverages B, C, and D of this invention were prepared using Emulsion III, IV, and V, respectively, following the procedure of Beverage A except that different emulsions were used.

The stability of these four beverages was monitored by weighing 300 grams each in a clear 10-oz glass bottle stored horizontally over the period of 6 weeks at ambient temperature. All beverage samples exhibited excellent stability without signs of creaming or ringing.

TABLE 6

| Ingredient | Gram/Liter |
|---|---|
| Emulsion I | 1 |
| Sugar syrup 74° Brix | 86 |
| Citric acid | 1.2 |
| Sodium benzoate | 0.2 |
| Water | q.s. to 1 Liter |

### Example 9

A beverage of this invention, i.e., Beverage E, using Emulsion I was prepared following the same procedure of Beverage A in EXAMPLE 8, except that sugar syrup 74° Brix was increased to 122 grams in the beverage composition. Beverage C of this invention was prepared following the same procedure of Beverage f except that Emulsion V was used.

The stability of these two beverages was monitored by weighing 300 grams each in a clear 10-oz glass bottle stored horizontally over the period of 6 weeks at ambient temperature. All beverage samples exhibited excellent stability without signs of creaming or ringing.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

Indeed, to prepare a flavor emulsion, one skilled in the art can choose different flavors, solvents, contents and ratios of polyethoxylated sorbitan fatty acid esters and lecithins, co-solvents, and the load of flavors in beverages. Further, a skilled person can also choose other adjunct materials and suitable stabilizing agents.

From the above description, a skilled artisan can easily ascertain the essential characteristics of the present invention, and without departing from the spirit and scope thereof, can make various changes and modifications of the invention to adapt it to various usages and conditions. Thus, other embodiments are also within the claims.

1. An oil-in-water emulsion comprising a plurality of oil droplets as an oil phase, an aqueous phase, and an emulsifier system,
wherein,
each of the oil droplets, having a droplet size of 0.05 μm to 10 μm in diameter, contains a functional ingredient system and disperses in the aqueous phase,
the emulsifier system contains an octenyl succinic anhydride (OSA)-modified starch having a weight average molecular weight of 3,000 Dalton or less when measured by GPC at a pH of 2.0.

2. The oil-in-water emulsion of claim 1, wherein the mean oil droplet size is 1 μm or less in diameter and the volume distribution of oil droplet size is 60% or higher below 1 μm.

3. The oil-in-water emulsion of claim 1, wherein the oil phase is present at a level of 1% to 30%, the emulsifier system is present at a level of 1% to 30%, and the functional ingredient system is present at a level of 0.1% to 20%, all by weight of the oil-in-water emulsion.

4. The oil-in-water emulsion of claim 1, wherein the emulsifier system further contains a co-emulsifier that is a chemically modified starch having a weight average molecular weight of greater than 10,000 Dalton when measured by GPC at a pH of from about 2.0 to about 4.5.

5. The oil-in-water emulsion of claim 1, wherein the emulsifier system further contains maltose.

6. The oil-in-water emulsion of claim 1, wherein the OSA-modified starch contains maltose in an amount of from about 15% to about 60%.

7. The oil-in-water emulsion of claim 4, wherein the weight ratio between the OSA-modified starch and co-emulsifier is 5:1 to 1:10, or preferable 3:1 to 1:5.

8. The oil-in-water emulsion of claim 1, wherein the weight ratio between the emulsifier system and the oil phase is 1:10 to 2:1, or preferably 1:5 to 1:1.

9. The oil-in-water emulsion of claim 1, wherein the functional ingredient system contains a flavor oil, a taste modulator, an acidulant, a carbohydrate, a nutraceutical ingredient, a colorant, a juice, a plant extract, a vitamin, or any combination thereof.

10. The oil-in-water emulsion of claim 9, wherein the taste modulator contains a steviol-based compound, non-steviol-based compound, or both.

11. The oil-in-water emulsion of claim 10, wherein the steviol-based compound is a glucosylated steviol glycoside, and the non-steviol-based compound is Luo Han fruit extract.

12. The oil-in-water emulsion of claim 9, wherein the acidulant is presented at a level of 0.1% to 2% and is citric acid, ascorbic acid, tartaric acid, malic acid, gluconic acid, or a combination thereof, and the carbohydrate is presented at a level of 0.1% to 20% and is a monosaccharide, disaccharide, hydrocolloid, or a combination thereof.

13. (canceled)

14. The oil-in-water emulsion of claim 1, wherein the oil phase contains a flavor compound and a taste modulator.

15. (canceled)

16. The oil-in-water emulsion of claim 1, wherein the density of the oil phase is 0.9 g/L to 1 g/L, preferably 0.92 g/L to 0.98 g/L.

17. The oil-in-water emulsion of claim 1, wherein the pH is below 5, preferably below 4.

18. A consumer product comprising the oil-in-water emulsion of claim 1, wherein the consumer product is a liquid beverage, liquid beverage concentrate, or dry beverage powder.

19. A method of preparing a flavor composition, the method comprising the steps of:
(a) providing an aqueous phase containing an OSA-modified starch having a weight average molecular weight of 3,000 Dalton or less when measured by GPC at a pH of 2.0.
(b) providing an oil phase containing a flavor oil, and
(c) emulsifying the oil phase into the aqueous phase, thereby obtaining the oil-in-water emulsion.

20. The method of claim 19, wherein the aqueous phase contains a taste modulator.

21. The method of claim 19, further comprising the step of spray drying the oil-in-water emulsion to obtain the flavor composition in the dry form.

22. The method of claim 19 further comprising the step of adding an acidulant to the aqueous phase to adjust pH of the aqueous phase to less than 5.
